(19) United States
(12) Patent Application Publication
(10) Pub. No.: US 2004/0023578 A1
(43) Pub. Date: Feb. 5, 2004

(54) Highly durable, coated fabrics exhibiting hydrophobicity, oleophobicity and stain resistance, and related methods

(76) Inventors: Robert T. Sobieski, Charlotte, NC (US); Raymond J. Weinert JR., Macedonia, OH (US); Rodney L. Cuevas JR., Columbus, MS (US); Daniel C. Gottschalk, Columbus, MS (US)

Correspondence Address: David C. Burleson, OMNOVA Solutions, Inc., 175 Ghent Road, Fairlawn, OH, 44333-3300, US

(21) Appl. No.: 10/427,740

(22) Filed: Apr. 30, 2003

Related U.S. Application Data
(63) Continuation-in-part of application No. 10/136,239, filed on May 1, 2002.

(51) Int. Cl. B32B 5/22; B32B 5/18

(52) U.S. Cl. 442/76

(57) ABSTRACT

The present invention provides a hydrophobic, oleophobic and stain resistant fabric comprising a woven, non-woven, or knitted fabric substrate coated with a polymer system comprising a scrub resistant first layer and a second layer comprising a fluoropolymer bonded to the scrub resistant first layer. A method for producing a hydrophobic, oleophobic and stain resistant fabric including the steps of selecting a suitable fabric substrate and applying first layer to form a scrub resistant first layer; drying and curing the scrub resistant first layer; applying a fluoropolymer coating over the first layer to form a second layer; and drying and curing the second layer. Articles comprising a fabric as described herein are also provided.

The present application claims the benefit of commonly assigned patent application having Ser. No. 10/136,239, filed on May 1, 2002, and entitled HIGHLY DURABLE, COATED FABRICS EXHIBITING HYDROPHOBICITY, OLEOPHOBICITY AND STAIN RESISTANCE AND RELATED METHODS.

### FIELD OF THE INVENTION

The present invention generally relates to water repellant and scrub resistant stain resistant fabrics and methods for making the same. More particularly, the present invention relates to coated fabrics that have properties of hydrophobicity and oleophobicity as well as stain resistance and method for its production, wherein a fabric substrate is coated with a polymeric system including a first layer composition forming a first layer and a second layer comprising a fluoropolymer.

### BACKGROUND OF THE INVENTION

Water repellency and stain resistance are important properties for many uses of textile materials, both domestic and industrial. Thus, various types of water repellant and stain resistant fabrics have been provided in the prior art. Many times, these fabrics are also produced with anti-microbial properties to further increase their service life. The term “anti-microbial” generally connotes a resistance to microbial growth and includes antibiotics, antifungal, antiviral and anti-algal agents.

While the prior art has provided water repellant and stain resistant fabrics, it has been found that the water repellency of these fabrics may not be satisfactory for given applications, and, at any rate, may be improved upon. The term “hydrophobicity” as used herein means that the fabric coating is water repellent and resists removal by washing. The term “oleophobicity” as used herein means that the fabric coating is resistant to attack and removal by oils. The two terms may be combined herein with reference to the term “repellent”. The term “stain resistant” as used herein means that the fabric coating exhibits high stain release. It has been found that the prior art, while being successful at providing fabrics with some degree of water repellency and stain resistance, does not provide fabrics having water repellant and stain resistant coatings that can survive a significant number of scrub cycles, i.e. washings.

U.S. Pat. Nos. 5,565,265, 5,747,392, 6,024,823, 6,165,920, 6,207,250, 6,251,210, assigned to High-Tex, Inc., of Farmington Hills, Michigan, disclose various stain and liquid resistant and/or liquid repellant fabrics and methods for their production. These patents also provide fabrics further exhibiting anti-microbial properties. The patents disclose the use of various chemical components including copolymers, acrylics, urethanes, fluoropolymers, antimicrobial agents, crosslinking agents, catalysts, and the like, and generally teach the creation of a polymer-based coating on a fabric substrate for imparting liquid and stain resistance. However, having considered those disclosures, it has been found that the durability of the coatings produced is inadequate. Particularly, it has been found that the coatings disclosed therein are susceptible to removal from the fabric substrate after significant, yet reasonable, washing cycles.

Additionally, in much of the prior art, a fluoropolymer component is blended with other polymer components to provide a single film-forming composition to be applied to the fabric. Mixing the fluoropolymer directly with other polymer components of the coating limits the choice of polymers available for creation of the fabric coating.

### SUMMARY OF THE INVENTION

The present invention provides a hydrophobic, oleophobic and stain resistant fabric comprising a woven, non-woven, or knitted fabric substrate coated with a polymer system comprising a scrub resistant first layer; and a second layer comprising a fluoropolymer bonded to the scrub resistant first layer.

The scrub resistant first layer acts as an adhesion enhancing layer between the fabric substrate and the fluoropolymer second layer. The first layer also preferably reinforces the yarn and provides stain resistance properties. For purposes of the present invention, the first layer is considered to act as an adhesion enhancing layer if a greater amount of the second layer is retained on the fabric under wear conditions as compared to a like sample having the same second layer on the same substrate without an intervening first layer. Similarly, the first layer is considered to reinforce the fabric substrate if the fabric has greater structural integrity under wear conditions as compared to a like fabric substrate without the first layer. A layer is considered to be stain resistant if when a staining material wets onto the surface of a substrate, the staining material is more easily removed from the substrate by conventional cleaning techniques than from a like substrate without the stain resistant layer.

The present invention also provides a method for producing a hydrophobic, oleophobic and stain resistant fabric, including the steps of selecting a suitable fabric substrate; applying a first layer comprising a polymer composition having reactive functional sites and having an affinity for the fabric substrate; drying and curing the first layer; applying a second polymer coating different from the first layer to the first layer, said second layer comprising a fluoropolymer having reactive functional sites; drying and curing the polymer coating; and reacting at least a portion of the reactive functional sites of said fluoropolymer with at least a portion of the reactive functional sites of the first layer. Intermediate or final steps may be employed to provide back coatings to the fabric substrate, and antimicrobial agents may be introduced via these back coatings.

Due to the bond of the second fluoropolymer layer with the first layer, the resultant two layer system coating on the fabric exhibits durability that is greater than that encountered in the prior art. That is, the present invention provides advantages over the prior art by first providing a durable first layer on the fabric to provide some stain resistance and, thereafter, at least partially reacting a fluoropolymer to that first layer to provide hydrophobicity and oleophobicity.

The methods as described herein provide substantial benefits in one aspect because certain components that are coated on the fabric are applied from separate compositions. The provision of these components in different coating compositions, which compositions may otherwise adversely or prematurely interact and/or react if they were provided in a single composition, enables the use of process materials having a long shelf life, and also more predictable coating characteristics over time. Thus, separate coating compositions may be prepared long in advance of the actual coating operation without concern as to pre-reaction of components. Additionally, flocculation or sedimentation of coating compositions is minimized during the coating operation because of the provision of potentially interactive components in separate coating compositions.

### DESCRIPTION OF THE DRAWINGS

FIG. 1 generally depicts a woven fabric, particularly a plain weave;

FIG. 1A is an enlarged view of the end section of yarn depicted in FIG. 1;

FIGS. 2A-2E are cross-sections of a woven fabric, taken substantially along the line 2-2 of FIG. 1, and show the proposed step-wise formation thereon of a coated fabric according to the invention having intermediate and final back coatings;

FIGS. 3A-3D are cross-sections of a woven fabric, taken substantially along the line 3-3 of FIG. 1, and show the step-wise formation thereon of a coated fabric according to the present invention having a single back coating; and

FIG. 4 provides a non-limiting exemplary schematic of the process for carrying out the present invention.

FIG. 5 is a graphic representation of hydrophobicity data of sample coated using a one layer process and a two layer process comprising a cationic fluoropolymer.

FIG. 6 is a graphic representation of hydrophobicity data of sample coated using a one layer process and a two layer process comprising an amphoteric fluoropolymer.

FIG. 7 is a graphic representation of hydrophobicity data of uncoated control samples.

FIG. 8 is a graphic representation of hydrophobicity data of sample coated using a delayed one layer process and a delayed two layer process comprising a cationic fluoropolymer.

FIG. 9 is a graphic representation of hydrophobicity data of sample coated using a delayed one layer process and a delayed two layer process comprising an amphoteric fluoropolymer.

### PREFERRED EMBODIMENT FOR CARRYING OUT THE INVENTION

The present invention utilizes processes and chemistries to provide a fabric substrate with a highly scrub resistant, stain resistant and repellant coating that preferably does not significantly affect the hand or feel of the fabric substrate. As used herein, “fabric substrate” relates to woven, knitted and non-woven fabrics of synthetic or natural materials or blends thereof. As used herein, the term “copolymer” encompasses both oligomeric and polymeric materials, and encompasses polymers incorporating two or more monomers. As used herein, the term “monomer” means a relatively low molecular weight material (i.e., generally having a molecular weight less than about 500 Daltons) having one or more polymerizable groups. “Oligomer” means a relatively intermediate sized molecule incorporating two or more monomers and generally having a molecular weight of from about 500 up to about 10,000 Daltons. “Polymer” means a relatively large material comprising a substructure formed two or more monomeric, oligomeric, and/or polymeric constituents and generally having a molecular weight greater than about 10,000 Daltons.

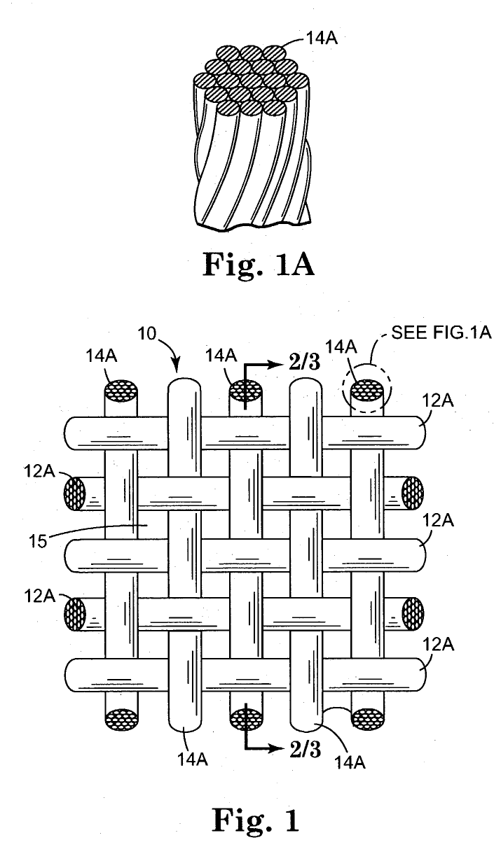

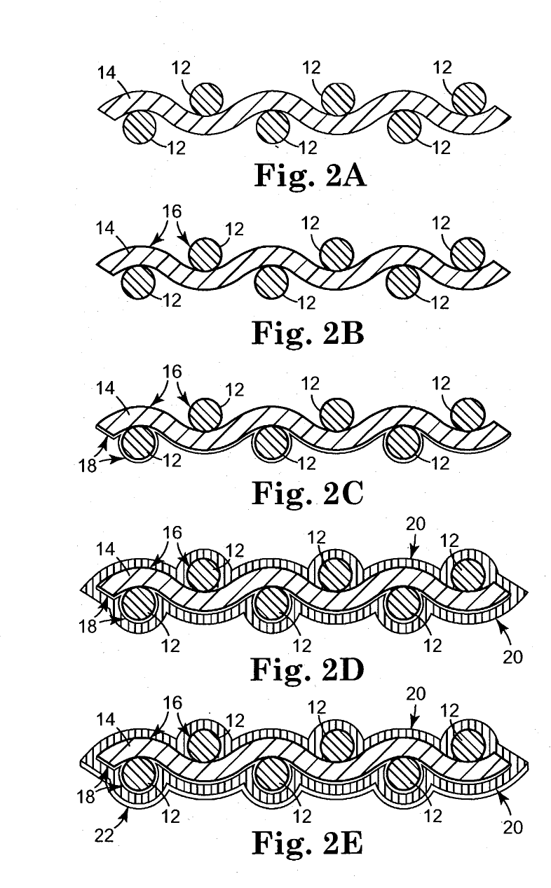

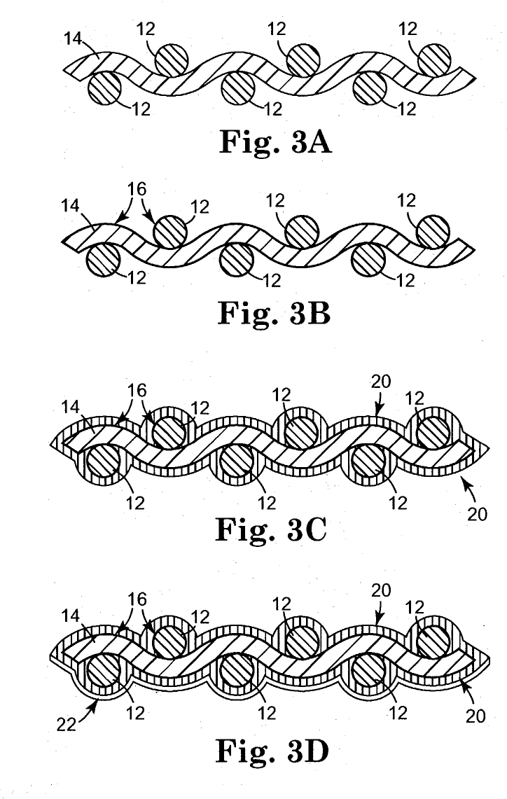

FIGS. 1-3 generally depict an uncoated plain weave fabric (FIG. 1) and plain weave fabrics coated according to the particular embodiments of the present invention (FIGS. 2 and 3). FIG. 1 simply depicts a plain weave fabric 10 having warp yarns 12 and fill yarns 14. FIG. 1 provides a cross-section reference for FIGS. 2A-2E and 3A-3D, as taken along the lines 2-2 and 3-3 of FIG. 1. In the embodiment of FIGS. 2A-2E, plain weave fabric 10 is first coated with a first layer 16 that is derived from the first layer coating composition. First layer 16 forms a coating on fabric 10, and is chosen according to considerations identified above and disclosed more fully hereinbelow. As depicted in FIG. 2C, fabric 10 includes an intermediate back coating 18 that is applied over first layer 16 on the back surface of fabric 10 before the application of the second layer (or fluoropolymer) coating 20, as shown in FIG. 2D. Back coating 18 is termed an “intermediate” back coating because, in the embodiment of FIGS. 2A-2E, two back coatings are employed. Notably, back coatings, when employed, may be conventional back coatings as known in the art, and may contain antimicrobial agents. As depicted in FIG. 2E, a second or first back coating 22 is applied over both the first layer 16, intermediate back coating 18, and the second layer 20; again on the back surface of the fabric 10.

In FIGS. 3A-3D, a similar step-wise formation of a coated fabric is provided; however, only one back coating is employed in FIGS. 3A-3D, like parts having received like numerals, as compared with FIGS. 2A-2E. Thus, fabric 10 includes a first layer 16, a second layer 20, and a single back coating 22. With particular reference to FIG. 3C, it can be seen that this fabric 10 does not include an intermediate back coating 18. Of course, one could also apply the intermediate back coating 18, in lieu of the back coating 22.

It is to be appreciated that, while the multiple back coating embodiment of FIGS. 2A-2E is preferred for reasons of providing hydrostatic head, a back coating need not be applied to practice aspects of the present invention. Thus, although not depicted in the drawings, the present invention can be practiced without the application of any back coatings to the fabric, which then will receive only the first and second layers. Back coatings, when employed, may be of conventional types and may contain conventional back coating additives, such as antimicrobial agents. Due to the fact that conventional back coatings affect the pliability of the fabrics to which they are applied, it may be preferable in some applications to include either no back coating or the single back coating of FIGS. 3A-3D to preserve the pliability of the fabric. However, in other applications, it may be advisable to employ more than one back coating, as depicted in FIGS. 2A-2E.

The compositions that are employed to provide the first layer 16 are compositions of one or more polymeric components and are chosen according to the particular fabric substrate being coated.

With reference to FIG. 1A, separate fibers 12A and 14A, comprising the warp and fill yarns 12 and 14, respectively, have been illustrated. The first layer coating composition at least partially penetrates the fabric substrate, wetting the individual fibers 12A, 14A, as well as flows through the interstices 15 between the warp and fill yarns. The first layer preferably does not occlude the interstices, as might a thick coating of wax, or plastic or rubber latex, but rather leaves it sufficiently porous for the passage of air. As the first layer coating composition is cured, the first layer can be likened to a fiber reinforced plastic, where the yarns and respective individual fibers comprise the fiber reinforcing the first layer, polymeric composition. It is to be understood that at least some of the separate fibers in the bundle are contacted by the first layer, while the innermost fibers may or may not be, depending upon such factors as the viscosity and surface tension of the first layer and the coating application technique, including pressures.

Fabric substrates of the present invention include woven fabrics (FIGS. 1-3) as well as non-woven and knitted fabrics, both of which are not shown. The term “yarn” typically refers to three types of component: monofilaments; multifilament bundles of filaments (including strands or fibers); and groupings of filaments that are twisted together, or so called spun yarns. Yams may be provided in various physical configurations, such as crinkle shapes and the like. As noted above, the first layer acts as an adhesion enhancing layer by exhibiting sufficient affinity to the fabric substrate to retain the coating on the fabric under wear conditions. In one aspect of the present invention, affinity may be accomplished mechanically, by physically penetrating the fabric matrix. In this aspect, the composition flows around and at least partially surrounds the filaments of the fabric. Where monofilaments are employed for the manufacture of a particular fabric substrate, physical surrounding of the filaments by the first layer coating composition will particularly occur at the interstices between crossovers of the monofilament, whereas for multifilament bundles and spun yarns of discrete fibers, physical surrounding of the yarns by the first layer coating composition will occur at the interstices between cross-overs as well as through partial or complete penetration of the composition between the individual separate fibers, such as 12A and 14A. Non-woven fabrics are typically made from continuous strands, as well as discrete fibers twisted together to form continuous strands of yarn. Hence, “partial penetration” of the first layer refers to interstices as well as separate components of the yarn, where applicable.

Alternatively or additionally, the first layer may achieve affinity to the fabric substrate by coordination, interaction or reaction of chemical moieties on the polymer of the first layer with chemical moieties on the fabric. Examples of such interactions include coulombic interaction, ionic bonding, covalent bonding, hydrogen bonding, London dispersion forces, dipole-dipole interactions, charge transfer complexation, and the like.

In a preferred embodiment of the present invention, both the fabric substrate and the first layer are provided with chemical moieties that are reactive functional groups capable of entering into covalent bonds. Such functionalities may, for example, be selected so that a functionality on the fabric substrate may be directly reacted with a functionality on a polymer in the first layer coating composition. For example, the fabric substrate may be provided with available acid functionality and the polymer in the first layer coating composition may be provided with an aziridine functionality, so that a direct reaction may occur. Alternatively, the functionalities may be selected so that a functionality on the fabric substrate is reacted with a functionality on an intermediate crosslinking material, which also is reacted with a functionality on the polymer in the first layer coating composition. For example, both the fabric substrate and polymer in the first layer coating composition may be provided with available carboxyl functionalities, with both being reacted with a polyfunctional aziridine compound to form a linkage between the substrate and the first layer. Likewise, covalent bonds may be formed using alternative systems that will now be apparent to those of ordinary skill in the art, such as the reaction of hydroxyl functional materials with materials having alkoxylated or partially alkoxylated melamine formaldehyde or urea formaldehyde functionality. Other reactive systems may be designed for reacting the polymer with the fabric in a manner that will now be apparent to those of ordinary skill in the art.

In another preferred embodiment, the first layer is provided with reactive functionality as discussed above, but the fabric contains few or no reactive functional groups. Upon application of the first layer to the fabric, at least a portion of said functionalities are reacted together or crosslinked, thereby creating and/or enhancing mechanical binding of the first layer to the fabric. While not being bound by theory, it is believed that portions of the first layer partially or completely surround at least some fibers of the fabric. When the polymers of the first layer are reacted or crosslinked together, a matrix is formed that tends to bind the first layer to portions of the fabric, thereby creating a strong affinity and durability of the first layer on the fabric. The crosslinkable functionalities are preferably selected from moieties as discussed above. Most preferably, only a portion of the reactive functionality of the first layer is reacted during the first application step, thereby leaving open reactive functionality available for subsequent reaction with the fluoropolymer as described herein.

If multiple polymeric components are employed for the first layer coating composition, a first polymeric component may be chosen based on a chemical affinity to the substrate, with the other polymeric components having an affinity to the first polymeric component. This combination of polymeric components in the first layer facilitates providing a plurality of desired physical and/or chemical properties in the first layer achievable in combination of multiple polymer components. For example, one polymer may be incorporated in the composition of the first layer to provide enhanced tensile strength performance to first layer, and a second polymer may be incorporated to provide an enhanced hardness and durability aspect to the first layer.

Alternatively or additionally, the first layer may achieve affinity by diffusion of components of the first layer into individual strands of the fabric.

The fluoropolymer compositions that are employed to give fluoropolymer coating 18 provide the fabric substrate with water and oil repellency and, to the extent that they repel water and other liquid stains, they also increase the stain resistant properties of the fabric. As with the first layer coating composition, the fluoropolymer includes available reactive functional sites. After the first layer is formed on the fabric substrate, the fabric substrate is coated with the fluoropolymer, which, through available functional sites, is bonded to the first layer, preferably with suitable crosslinking agents. As mentioned, back coatings may be applied in intermediate and final passes, and preferably contain antimicrobial agents.

In one embodiment of the present invention, the same reactive functional groups are provided on the fabric, on polymers of the first layer, and fluoropolymers of the second layer, and the same crosslinking agent is provided during the coating process of each layer to crosslink the layer to the material on which it is coated. In this embodiment, the first layer is coated on the fabric, and an amount of crosslinking agent that is less than required to react with all of the available functional groups in the first layer coating composition is provided during the coating process. Thus, the first layer in this embodiment is covalently bonded to the fabric substrate, and yet still contains available reactive functionality for reaction with the second layer. The second layer is then coated on the first layer together with a sufficient amount of crosslinking agent to form covalent bonds between the fluoropolymer and the first layer.

In another embodiment of the present invention, polymers of the first layer coating composition are provided with a plurality of sets of reactive functional groups, one set selected to react with functional groups on the fabric (either with or without crosslinking agents), and the other set selected so that they will not react with the functional groups on the fabric, but will react with functional groups on the fluoropolymer (either with or without crosslinking agents). In this embodiment, control of the amount of crosslinking agent in the coating process of the first coating is not as critical, because availability of functional groups that will react with the fluoropolymer is assured even if an excess amount of crosslinker is inadvertently used.

In another embodiment of the present invention, polymers of the first layer coating composition are provided with reactive functional groups that will react directly with reactive functional groups on the fabric, and also with reactive functional groups on the fluoropolymer. In this embodiment, the reactive functional groups are not identical on all three elements of the coated fabric construction, but rather the functionalities on the fabric and on the fluoropolymer are different from and reactive with the functionalities of the first layer. Optionally, bridging compounds or crosslinking agents may be used in this embodiment to form bonds between the fabric and the first layer and/or the fabric and the fluoropolymer.

In another embodiment of the present invention, polymers of the first layer coating composition are provided with functional groups that will interact with functionalities on the fabric, exhibiting a chemical affinity to the fabric as discussed above. Polymers of the first layer coating composition are also are provided with reactive functionality that will react with reactive functional groups on the fluoropolymer, either with or without bridging compounds or crosslinking agents.

In embodiments where the first layer coating composition comprises one set of functionalities for interaction with the fabric and another set of functionalities for reaction with the fluoropolymer, preferably both sets are present on the same polymer. Optionally, one set of functionalities may be provided on one polymer, and another set of functionalities are provided on a different polymer in the first layer coating composition. Preferably, the polymers of this last alternative are relatively high in molecular weight and compatibility, so that the two different types of polymers of the first layer coating composition are entangled when in the form of a coating, thereby enhancing the abrasion resistance and retention of the fluoropolymer on the fabric.

The fabric substrates employed in this invention may be chosen from woven, knitted, and non-woven fabrics of natural or synthetic yarns. Non-limiting examples of suitable fabric substrates for use according to this invention include synthetic fabrics such as polyesters, nylons, rayons, thermoplastic polyolefins, and the like, and natural fabrics, such as cotton, flax, jute, ramie, and the like. A suitable fabric substrate may also consist of a blend of natural and synthetic fabric materials. In a particularly preferred embodiment of this invention, the fabric substrate is a polyester. Also preferred are fabric substrates comprising blends of polyesters with cotton.

The first layer coating composition includes one or more polymeric components selected according to their affinity with the fabric substrate and ability to form a scrub resistant film. The polymers of the first layer are preferably selected to provide a balance of ease of film forming under manufacturing conditions, together with durability of the resultant layer and acceptable hand of the final fabric.

The properties of the first layer can also be affected by mixing polymers having a relatively low glass transition temperature (“soft polymers”) with polymers of relatively high glass transition temperatures (“hard polymers”). Preferably, the polymer components of the first layer are selected to balance the characteristics of the resulting coating, so that the a film is formed under processing conditions while at the same time the final first layer coating is hard enough to be durable under conditions of use. In general, hard polymers are more durable and more stain resistant. Soft polymers generally exhibit more affinity to the fabric due to greater conformation to the surface of the fabric, and tend to readily coalesce under convenient processing conditions to form a film. Preferred soft polymers have a glass transition temperature of below about 30° C., and preferably from about −30° C. to about 10° C. Preferred hard polymers have a glass transition temperature of above about 100° C., and more preferably from about 120° C. to about 180° C.

Preferably, the composition of the first layer is a blend of soft and hard polymers comprising about 5% to about 95% of soft polymers and about 95% to about 5% of hard polymers by weight, and more preferably about 10% to about 45% of soft polymers and about 55% to about 90% of hard polymers by weight. Most preferably, the composition of the first layer comprises about 20 to about 35% of soft polymers and about 65 to about 80% of hard polymers by weight. In a preferred embodiment of the present invention, the polymers of the first layer are predominantly aliphatic in nature. Aromatic functional groups may raise stability and/or discoloration issues in certain environments, and therefore may be less desirable. Polymers are preferably selected from water dispersible polymers, such as acrylate and/or methacrylate jointly referred to as “(meth)acrylate”) copolymers, urethanes, polyesters, polyethers, polycarbonates and hybrids of one or more of these polymers.

Polymers useful for the present invention may be formed from copolymerized monomers having a combination of monomers that result in a copolymer having characteristic properties. The Tg and other properties of the copolymer may be tailored to the desired properties by incorporation of various selected monomeric compounds during the polymerization process. Thus, soft monomers are preferably incorporated to impart flexibility and toughness to the copolymer, and so that the resulting copolymer exhibits the desired low Tg property. Likewise, hard monomers are incorporated to impart hardness and durability to the copolymer, and so that the resulting copolymer exhibits the desired high Tg property. Monomers may be characterized as “soft” monomers or “hard” monomers by consideration of the Tg of the corresponding homopolymers made from the designated monomer. Thus, for purposes of the present invention, a monomer is considered to be a “soft” monomer if the corresponding homopolymer has a Tg of less than about 25° C. Similarly, a monomer is considered to be a “hard” monomer if the corresponding homopolymer has a Tg of more than about 25° C.

Polymers of the first layer coating composition are selected to provide the desired chemical functionalities for providing affinity to a selected fabric substrate and for reactivity to the fluoropolymer of the second layer. Examples of preferred functionalities include hydroxyl and/or carboxyl groups.

A preferred first layer of the present invention comprises a (meth)acrylate copolymer as one of the polymers of the composition. (Meth)acrylate copolymers may be formulated to provide a desired Tg, and also may be provided with useful functionality both for providing affinity to a selected fabric substrate and for reactivity to the fluoropolymer of the second layer. Monomer selection is important for performance of the layer on the fabric, particularly in applications where the fabric is expected to be exposed to substantial UV radiation, such as direct sunlight, and particularly outdoors. For example, vinyl toluene and styrene may lead to yellowing if added in large amounts (e.g. greater than 20%).

The soft monomer is typically soft monomeric acrylic or methacrylic acid ester of an alkyl alcohol containing a single hydroxyl, the alcohol being further described as having from 2 to about 14 carbon atoms when the soft monomer is an acrylic acid ester, and about 7 to 18 carbon atoms when the soft monomer is a methacrylic acid ester.

Examples of suitable acrylic acid esters for use as the soft monomer include the esters of acrylic acid with non-tertiary alcohols such as ethanol, 1-butanol, 2-butanol, 1-pentanol, 2-pentanol, 3-pentanol, 2-methyl-1-butanol, 1-hexanol, 2-hexanol, 2-methyl-1-pentanol, 3-methyl-1-pentanol, 2-ethyl-1 butanol, 3,5,5-trimethyl-1-hexanol, 3-heptanol, 1-octanol, 2-octanol, iso-octyl alcohol, 2-ethyl-1-hexanol, 1-decanol, 1-dodecanol, 1-tridecanol, 1-tetradecanol and the like.

Examples of suitable methacrylic acid esters for use as the soft monomer include the esters of methacrylic acid with non-tertiary alcohol such as 3-heptanol, 1-octanol, 2-octanol, iso-octyl alcohol, 2-ethyl-1-hexanol, 1-decanol, 1-dodecanol, 1-tridecanol, 1-tetradecanol, 1-octadecanol and the like.

Other examples of monomers that can be used for the soft monomer component are monomers having the requisite Tg values including dienes, such as butadiene and isoprene; acrylamides, such as N-octylacrylamide; vinyl ethers, such as butoxyethylene, propoxyethylene and octyloxyethylene; vinyl halides, such as 1,1-dichloroethylene; and vinyl esters such as vinyl versatate, vinyl caprate and vinyl laurate.

It is to be understood that the copolymer may comprise a single type of soft monomer or may comprise two or more different soft monomers.

A hard monomer of the copolymer is typically a monomeric methacrylic acid ester of an alkyl alcohol containing a single hydroxyl. The alcohol contains from 1 to about 6 carbon atoms, and preferably 1 to about 4 carbon atoms. Examples of suitable monomers for use as the hard monomer include the esters of methacrylic acid with non-tertiary alcohols such as methanol, ethanol, 1-propanol, 2-propanol, 1-butanol, 2-butanol, 1-pentanol, 2-pentanol and 3-pentanol.

Other examples of monomers that can be used for the hard monomer component are monomers having the requisite Tg values include methacrylates having a structure other than delineated above, such as benzyl methacrylate, cyclohexyl methacrylate and isobornyl methacrylate; methacrylamides, such as N-t-butylmethacrylamide; acrylates, such as isobornyl acrylate; acrylamides, such as N-butylacrylamide and N-t-butylacrylamide; diesters of unsaturated dicarboxylic acids, such as diethyl itaconate and diethyl fumarate; vinyl nitriles, such as acrylonitrile, and methacrylonitrile; vinyl chloride; vinyl esters, such as vinyl acetate and vinyl propionate; and monomers containing an aromatic ring such as styrene; alpha-methyl styrene and vinyl toluene.

It is to be understood that the copolymer may comprise a single type of hard monomer or may comprise two or more different hard monomers.

Monomers that may be used to provide hydroxyl functionality for interaction and/or reaction with the fabric or fluoropolymer include the hydroxyalkyl (meth) acrylates, such as 2-hydroxethyl (meth) acrylate, 2-hydroxypropyl (meth) acrylate, 4-hydroxybutylacrylate, 6-hydroxyhexylacrylate, p-hydroxycyclohexyl (meth) acrylate, hydroxypolyethylene glycol (meth) acrylates, hydroxypolypropylene glycol (meth) acrylates and alkoxy derivatives, and dipropylene glycol diacrylate.

Functional monomers may be incorporated into the copolymer, for example, to facilitate physical interaction with another polymer or material. Examples of such functional monomers include acrylic acid, acrylamide, vinylpyrrolidone or dimethyl aminomethyl methacrylate. The identity of the monomer to be incorporated is determined depending on the coupling mechanism to be used for adhering the first layer to the fabric, or for bonding the fluoropolymer to the first layer. Monomers that may be used to provide carboxyl functionality for interaction and/or reaction with the fabric or fluoropolymer include acrylic acid, methacrylic acid, maleic acid, and itaconic acid.

Other acid functionality may be provided by formation of the polymer with monomer containing the desired functionality. Optionally, reactive functionality may be introduced into the polymer during the polymer formation process. For example, acrylate polymers comprising sulfonate functionality may be formed during the polymerization process, wherein the polymerization reaction is initiated using a persulfate, such as sodium or ammonium persulfates. The sulfonate functionality typically is provided as end groups on the acrylate copolymer.

As noted hereinabove, the polyurethanes preferably also may be a polymer component of the first layer coating composition. The preparation of polyurethanes generally proceeds in a stepwise manner as by first reacting a hydroxyl terminated polyester or polyether (reaction of polyols plus hydroxyl terminated carboxylic acid dispersants plus polyisocyanates and sometimes plus a chain extender). Polyurethanes are converted to a polyurethane dispersion through neutralization of the polyurethane reaction usually with an amine (trimethylamine, triethylamine and dimethyl-ethanolamine) in the presence of a carboxylic acid dispersant. The neutralizing agents are preferably at a stoichiometric ratio of 0.9 to about 1.2. Once neutralized, water is added to the reaction mixture. A particularly useful polyurethane is a waterbome aliphatic polycarbonate urethane polymer manufactured by Stahl, Massachusetts, under the trade name WF41-035.

The polyisocyanates are prepared at a reaction temperature of about 40° C. to 160° C. using a catalyst and polyfunctional diisocyanates. Catalysts used include dibutyl tin dilaurate, stannous octoate, diazobicyclo (2,2,2) octane (DABCO), zinc acetyl acetonate (ACAC), and tin octoate. A suitable polyisocyanate is R(NCO)ₙ, where n is an integer of 2, 3 or 4. Examples of suitable polyisocyanates include hexamethylene diisocyanate, 2,2,4-and/or 2,4,4-trimethyl hexamethylene diisocyanate, p- or m-tetramethyl xylene diisocyanate, methylene bis(4-cyclohexyl isocyanate) (hydrogenated MDI), 4,4-methylene diphenyl isocyanate (MDI), mixtures of MDI with polymeric MDI having an average isocyanate functionality of from about 2 to about 3, 2, p- and m-phenylene diisocyanate, 2,4- and/or 2,6-toluene diisocyanate (TDI) and adducts thereof, and isophorone diisocyanate (IPDI).

The polyols can be polyether polyols, polyacetal polyols, a polyolefin polyols, organic polyols (e.g. polycarbonate polyols), or polyester polyols. The number average molecular weight for the polyols are between 400 to 15,000. Examples of the polyether polyols include polyoxypropylene or polyoxy ethylene diols and triols, poly(oxyethyleneoxypropylene) diols and triols. Examples of the polythioether polyols include glycols, dicarboxylic acids, formaldehyde, aminoalcohols or aminocarboxylic acids. Examples of the polycarbonate polyols include products obtained by reacting monomers such as diols having from 2 to 10 carbon atoms such as 1,3-propanediol, 1,4-butanediol, 1,6-hexanediol, diethylene glycol or tetraethylene glycol with diaryl carbonates having from 13 to 20 carbon atoms, for example diphenyl carbonate, or with phosgene.

A preferred low Tg polymer is a (meth)acrylate copolymer comprising about 70-90% of one or more soft monomers and 5-30% of one or more hard monomers, all selected so that the Tg of the copolymer is from about −30 to about 10° C. More preferably, the low Tg polymer comprises about 20-40% butyl acrylate, about 30-50% ethyl acrylate, and about 5-15% acrylic acid.

Hard polymers are preferably selected for their durability and stain resistant properties. Preferably, the hard polymers are hard enough to withstand conventionally applied forces used for removal of stains from fabric substrates in the field of use of the particular fabric to be treated. Additionally, the hard polymer is selected to be hydrolytically stable under conventionally applied cleaning solutions or anticipated staining materials to which the fabric substrates are expected to be exposed in the field of use of the particular fabric to be treated. The hard polymers are preferably hydrolytically stable to prolonged exposure (e.g. 24 hours) to a conventionally applied alkaline cleaning solution, such as Formula 409® cleaner, and to a dilute acid solution such as vinegar having 5% acidity.

Preferred hard polymers include selected polyurethane polymers, and particularly polyurethane/polycarbonate polymers. Preferred commercially available polymers include WF 41-035 from Stahl, USA.

In particular embodiments of this invention, the first layer coating composition comprises a water-borne urethane polycarbonate having pendent carboxyl groups and a carboxylated acrylic copolymer in amounts of from about 5 to about 95 parts by weight of the urethane polycarbonate with from about 95 parts to about 5 parts by weight of the acrylic copolymer, to total 100 parts by weight of dry solids. More preferably, the composition comprises from about 65 dry to about 75 dry parts by weight of the urethane polycarbonate polymer with from about 35 dry parts to about 25 dry parts by weight of the acrylic copolymer.

The second layer comprises a fluoropolymer having reactive functional groups that may be bonded to polymers of the first layer. Most preferably, the fluoropolymer is covalently bonded to polymers of the first layer. It has particularly been found that covalent bonds provide superior retention of the fluoropolymer to the first layer, and thus the fabric, under conditions of wear. The second layer may optionally comprise additionally components, and particularly additional polymeric components, provided that the additional components do not deleteriously affect the stain repellant properties of the second layer to a degree to reduce the efficacy of the layers to below acceptable performance of the ultimate coated fabric. Preferably, the second layer comprises no more than about 25% by weight of dry component other than fluoropolymer, and more preferably no more than about 10% of non-fluoropolymer additional components.

Generally, any commercially available repellant fluoropolymer may be employed according to this invention, with the proviso that the fluoropolymer is chosen to have functional sites that can be reacted to functional sites in the first layer. Fluoropolymers that may be used in this application are well known to those of ordinary skill in the art and include all of the fluorochemical textile treating agents. In particular, any of the fluoropolymer/fluorochemical textile treating agents disclosed in U.S. Pat. Nos. 5,565,265; 5,747,392; 6,024,823; 6,165,920; 6,207,250 and 6,252,210 can be employed, provided that the fluoropolymer has functional sites that can be reacted to functional sites in the first layer. The subject matter of these patents is incorporated herein by reference.

Useful fluoropolymers for practice of the present invention and commercially available include Zonyl 8412 from DuPont, and Sequapel GFC from OMNOVA Solutions, Inc. In a preferred embodiment of the present invention, the fluoropolymer comprises pendent fluorinated groups linked to the polymer through an ether linkage. Alternative materials may include fluorinated oxetane co- or ter-polymers prepared by OMNOVA Solutions, as described in U.S. Pat. Nos. 5,650,483; 5,668,250; 5668,251; and 5,663,289, the subject matter of which is incorporated herein by reference. In a preferred embodiment of the present invention, the fluoropolymer is prepared from monomers or oligomers comprising at least one fluorinated oxetane monomer. Preferably, the fluoropolymer comprises perfluorinated or highly fluorinated functionalities, wherein pendent fluorinated groups have a carbon chain length of equal to or less than four carbons. Such short chain fluorinated moieties have been shown to have low bioaccumulation in living organisms. Perfluorocarbon moieties of up to four carbon atoms in length are thus particularly useful. Alternatively, acrylic, polyether and epoxy based materials can be made utilizing fluorinated moieties based on heptafluorobutyl, perfluoropropyl, and trifluoro ethyl pendant groups that are non-bioacumulative.

Due to the present disclosure, those of ordinary skill in the art are now readily able to select an appropriate fluoropolymer based upon the available functional sites of the first layer. Preferred fluoropolymers comprise carboxyl functionalities that may react with functionalities on a polymer of the first layer or with polyfunctional compounds useful as crosslinking agents. A preferred example of such fluoropolymers is Sequapel GFC, commercially available from OMNOMVA.

As discussed above, crosslinking agents are preferably employed to bond the fluoropolymer to at least one polymer of the first layer, and also may be employed to bond the first layer to the fabric. For purposes of brevity, the use of the crosslinking agent will be illustrated in the context of bonding the fluoropolymer to the first layer, but it will be understood that similar principles apply in bonding the first layer to the fabric substrate or an intermediate layer. When the fluoropolymer and at least one polymer of the first layer contain hydroxyl functionalities, the polyfunctional compounds may be, for example any appropriate crosslinking agent reactive with hydroxyl functionalities. Preferred crosslinking agents include the melamine formaldehyde crosslinking agents, such as Resimene 735 commercially available from Solutia Inc., St. Louis, Mo. Alternative preferred crosslinking agents include the urea formaldehyde crosslinking agents, such as GP®2981 commercially available from Georgia-Pacific Corporation, Atlanta, Ga.

In an alternative embodiment, the first layer and the fluoropolymer can both comprise acid functionalities (such as carboxyl and sulfonyl), and the polyfunctional compounds may be, for example any appropriate crosslinking agent reactive with acid functionalities. Preferred crosslinking agents include the tri-functional aziridines, such as Xama-7 commercially available from Bayer.

The crosslinking agent may be provided in the first layer coating composition, in the second layer coating composition, or as a separate composition that is applied before, after or during the coating process of applying each respective layer to the fabric substrate.

The crosslinking agent is provided in an amount effective to achieve the desired level of bonding. When the crosslinking agent is provided in the respective coating compositions, preferably it is present at up to about 5 php, preferably, from about 0.5 to about 1.5 php (parts per hundred polymer). Coating compositions used in the present invention, including the first layer coating composition, fluoropolymer composition, optional additional coating compositions, optional back coating compositions, may optionally additionally comprise additional components suitable for incorporation in coating compositions. A number of such optional additives are commonly employed in the art. These optional additives include wetting agents; coalescing agents; curatives; catalysts, which may be employed to facilitate the activation of crosslinking agents and thereby aid in the formation of a layer through partial crosslinking or coalescence of the layer coating composition; antimicrobials; defoamers, which may be employed to suppress excessive foaming of the composition; and other additives generally employed in this field. These additives would be present in conventional amounts, chosen so as to not have a negative impact on the properties of the respective layer.

The coating compositions can also include surfactants for the dispersion of the polymers and/or to serve to reduce the surface tension of the coating composition to allow for proper wetting and penetration around fibers of the substrate on which the coating composition is applied. Examples of preferred surfactants include hydroxyl terminated carboxylic acid dispersants, which are organic compounds that contain one or more carboxyl groups and two or more hydroxyl groups (e.g. 2,2-dimethylol propionic acid). Other useful surfactant compounds include the fumarate polyether glycols described in U.S. Pat. No. 4,460,738, the subject matter of which is incorporated herein by reference. Other useful carboxyl-containing surfactant compounds include aminocarboxylic acids, for example lysine, cystine and 3,5-diaminobenzoic acid.

The coating compositions can also include a non-rewetting surfactant to facilitate coating of one or more layers. Such non-rewetting surfactants preferably thermally decompose during the drying step after coating of the layer, and therefore are not present in the layer to interfere with the adhesion of subsequently coated layers. The non-rewetting surfactant additionally is particularly preferred for use in the fluoropolymer-containing second layer as compared to traditional surfactants. Traditional surfactants are at least partially hydroscopic, and therefore their presence in the outer layer of the final dry coated fabric material is not desired because they would work in opposition to the stain repellant properties of the fluoropolymer-containing second layer. A particularly preferred non-rewetting surfactant is amine oxide, which is preferably provided in amounts from about 5 to about 10 php in each of the coating compositions. Preferably, the amine oxide is included at from about 6 to about 8 php.

As noted above, one or more intermediate back coatings (e.g., back coating 22, FIG. 3) may optionally be applied to the fabric substrate to give hydrostatic head and/or protect from bacterial and bacterial by-product migration. This optional back coating is a conventional coating as known in the art, and is applied only to the rear or back face of the fabric. The back coating in particular preferably contains an antimicrobial agent, which serves to preserve the structural integrity of the fabric substrate against deterioration by bacteria, fungus, algae, and other microbial organisms. If this back coating is employed, it is fully dried, as known in the art, before application of the fluoropolymer in a subsequent pass.

The composition of the back coating is generally based upon conventional acrylic latices as are well known in the industry. A useful back coating is Performax 3714, a proprietary acrylic formulation supplied by Noveon (Ohio, USA). A formulation for a first layer includes 45 to 50% film-forming acrylic water based emulsion; 22-27% filler, such as calcium carbonate; 10-12% thickener e.g., an alkali swellable material; 1-3% crosslinker, such as an urea formaldehyde; 0.5-1% defoamer; 1-2% surfactant and 1-2% amine.

When more than one back coat is used, the coatings may be of the same or different chemical composition.

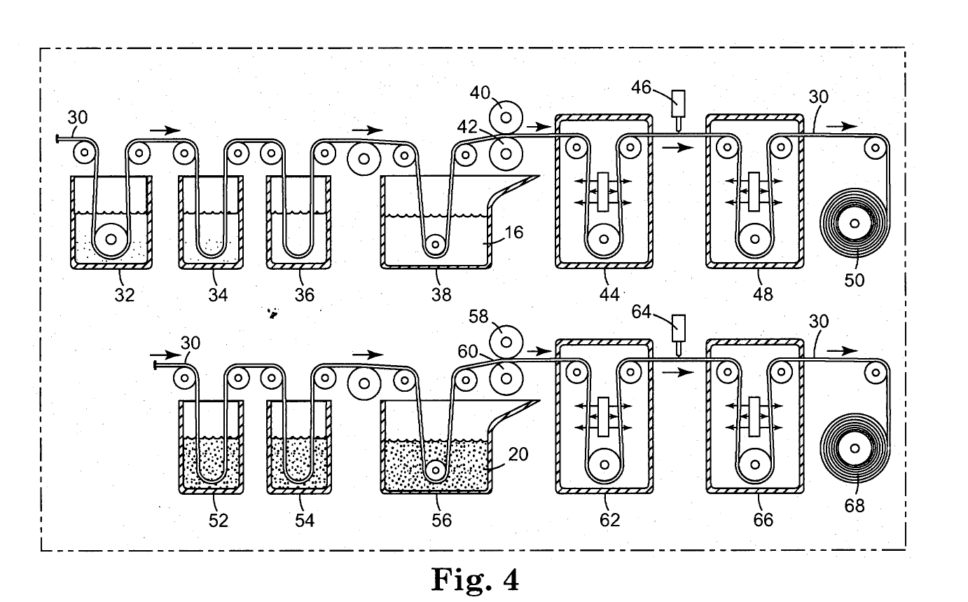

Turning now to the exemplary process as presented in schematic form in FIG. 4, the fabric substrate is preferably first cleaned by scouring the fabric to eliminate any residual sizing agents left from fabric production that might cause the fabric to be hydroscopic. The fabric 10 is then let off from a suitable source (not shown) and is passed through a scouring tank 32, containing water and a strong detergent, such as trisodium phosphate, after which it passes through first and second wash tanks 34 and 36; containing water. Once cleaned, the first coating is applied to the fabric substrate. Immediately following washing, the fabric is next fed into a first dip coating tank 38, for application of the first layer coating composition 16. Thus, both sides are coated in one pass, and the fabric carrying the wet base composition is passed between opposed rolls 40, 42, or doctor blades (not shown) to apply pressure to the fabric substrate 10 after wet pick-up of the first layer coating composition and thereby help to ensure that the interstices within the fabric substrate 10 are also coated. The rolls 40, 42 may also help to remove any excess amount of the first layer coating composition picked-up on the fabric 10 during its passage through the bath 16.

Next, the wetted fabric 10 is passed through a drying oven 44 where the first layer is dried via removal of water and other volatiles at a temperature and for a residence time sufficient to at least partially cure the first layer. If a back coating is to be employed, such as back coating 18 of FIG. 2C, it may be applied by a knife blade 46,after drying of the first layer. The substrate carrying the first layer and optional back coating is then passed through the curing stage 48, where additional heat is applied to cure the first layer and the back coating. After drying and curing, the fabric substrate 10, now coated with a first layer 16 and, optionally, a back coating 18 is collected on a take-up roll 50.

For the method depicted in FIG. 4, the fabric 10 is first taken up on roll 50 where it is then transported to the next stage, as will be described now. Take-up roll 50 is an optional, non-limiting step in the method, as the fabric 10 could as readily have been continuously directed through subsequent stages of the apparatus. Either way, the fabric 10 is next subjected to additional washings by passing through wash tanks 52 and 54. Immediately following washing, the fabric is next fed into a second dip coating tank 56, for application of the fluoropolymer composition 20. Again, both sides are coated in one pass, and the fabric carrying the wet base composition is passed between opposed rolls 58, 60, or doctor blades (not shown) to apply pressure to the fabric substrate 10 after wet pick-up of the fluoropolymer composition and thereby help to ensure that the interstices within the fabric substrate 10 are also coated. The rolls 58, 60 may also help to remove any excess amount of the fluoropolymer composition picked-up on the fabric 10 during its passage through the bath 20.

Next, the wetted fabric 10 is passed through a second drying oven 62 where the fluoropolymer composition is dried via removal of water and other volatiles at a temperature and for a residence time sufficient to at least partially cure the second layer. If a back coating is to be employed, such as back coating 22 of FIG. 2E, it may be applied by a knife blade 64, after drying of the first layer. The substrate carrying the second layer and optional back coating is then passed through the second curing stage 66, where additional heat is applied to cure the second layer and the back coating. After drying and curing, the fabric substrate 10, now coated with first layer and second layers 16 and 20, and optional back coatings 18 and 22, is collected on a final take-up roll 68.

For practice of an alternate method, where only one back coating layer is applied, as in FIGS. 3A-3D, only one back coating 18 or 22 is applied, with the understanding that the fabric passes from drying to curing of one of the layers without application of the back coating. The present invention also contemplates coated fabrics containing only first and second layers of polymeric materials as described herein, and no back coatings. It is also to be appreciated that although the apparatus and method has been described schematically with reference to tanks and rollers that guide the fabric through the compositions as well as through drying and curing ovens or stages, that alternative equipment could be substituted.

Once the fabric 10 containing the first layer and optional back coating leaves the first curing oven 48; these layers are not removed in the second stage washing tanks 52 and 54, prior to application of the fluoropolymer layer. Second stage washings merely remove excess surfactants, if any.

The focus in applying the first layer is on the dry pick-up of the first layer onto the fabric substrate. As those of ordinary skill in the art will readily appreciate, the weight percent of bath solids may vary to a large degree. For instance, if the bath contains a high percentage of solids, a lower wet pick-up is required to realize a dry pick-up that is satisfactory for forming the scrub resistant first layer, while, if the bath contains a lower percentage of solids, a higher wet pick-up is required to realize a satisfactory dry pick-up.

While it should be appreciated that the dry pick-up on the fabric substrate may vary according to the desired properties for the resultant coated fabric, the dry weight of the first layer picked up in this pass may range from about 1 to about 10 percent of the weight of the fabric substrate. Preferably, the dry weight ranges from about 4 to 6 percent of the fabric weight.

Generally, when considering the dry pick-up on the fabric, for abrasive and stain resistant properties, a larger dry pick-up is desired. However, it will be appreciated that aesthetics will be negatively affected as the amount of dry pick-up increases. The greatest amount of practical dry pick-up, with the highest level of stain and non-abrasive polymer constituent, can be arrived at experimentally with the principles described herein.

In a particular embodiment of this invention, the fabric substrate is a polyester, and the first layer coating composition is a carboxylated acrylic copolymer and polycarbonate urethane polymer blend. More particularly, the acrylic copolymer is Hycar T-138 (Noveon, Ohio, U.S.A.), and has carboxyl and sulfonate groups that make it possible to crosslink with itself or other polymer systems such as acrylics, urethanes, and/or fluoropolymers sharing the same type of functionality. This acrylic copolymer has a low glass transition temperature (Tg) of about −20° C., which permits the blending of this acrylic copolymer with a relatively hard polymer, while maintaining the hand and feel of the fabric being coated. Thus, this acrylic copolymer, in the preferred embodiment, is blended with a urethane latex, namely WF41-035 (Stahl, Mass., U.S.A.), which contains pendant carboxyl groups and has a Sward hardness of about 50.

The first layer coating composition bath is made up of WF41-035 and HycarT-138, blended at from 10 to 50%_{dry} acrylic polymer to from 90 to 50%_{dry} urethane. The bath also contains a small concentration, up to about 5 php, of trifunctional aziridine, a crosslinking agent, and from about 2 to about 6 php of amine oxide, a non-re-wetter. The polyester fabric of this preferred embodiment is passed through this bath to achieve a wet pick-up of from about 40 to about 50%, correlating to a dry pick-up in the area of about 2%.

The acrylic copolymer and urethane blend that forms the major portion of the first layer coating composition is caused to partially crosslink through the aziridine crosslinking agent, which forms a minor portion of the first layer bath. Notably, when crosslinking is employed to form the first layer, the composition is only partially reacted so that available functional sites are still present for binding with a fluoropolymer that is subsequently applied to the fabric substrate as described hereinbelow.

The fluoropolymer of this embodiment is Sequapel GFC (OMNOVA Solutions, Inc., Ohio, USA.), which is a fluorinated acrylate having active hydrogen (carboxyl) groups within the polymer matrix. These groups allow the fluoropolymer to be bound to the blend of acrylic copolymer and urethane polymer that makes up the first layer due to the fact that the first layer, as mentioned above, contains active carboxyl groups. The fluoropolymer is the major solid component while aziridine is present at from about 0.5 to about 1.5 php, and amine oxide is present from about 6 to about 8 php. The polyester fabric of this preferred embodiment is passed trough the fluoropolymer composition bath to achieve a dry pick-up of from about 0.25 to about 15 percent by weight.

The back coating material of acrylic material was applied twice, as two coatings, once after the first layer was applied and partially cured and once after the 10 second layer was applied and partially cured. The composition is based on a soft water based emulsion, containing filler, thickener, a urea-formaldehyde crosslinker, defoamer and wetting agent.

Affinity of the first layer may be evaluated by appropriate testing protocols designed to evaluate the retention of the second layer of the coating system on the fabric under wear conditions. Preferably, the wear testing is selected to model situations that would be predictive of the wear of the fabric under the anticipated conditions of use of that fabric. Such tests are apparent to one of ordinary skill in the art, and include abrasion resistance tests, tape peel tests, flex tests, and the like. The presence of the second layer may be evaluated visibly by the unaided eye, or more preferably through the use of photomicroscopy to closely examine the filaments of the fabric to determine the presence or absence of a coating. Additional evaluation tests may include contact angle evaluations, which will identify the presence or absence of a coating that is wetted or not wetted by the liquid used in the evaluation. Evaluation of oleophobicity is preferably performed in accordance with a test comprising evaluation of the surface tension of the fabric using a selected series of liquid hydrocarbons having varied surface tensions. Oil repellency is graded by identifying the highest numbered test liquid that does not wet the fabric surface. A preferred test for evaluating oleophobicity is AATCC test 11897, or ISO 14419 test method. Similarly, hydrophobicity is preferably evaluated using a selected series of aqueous liquids having varied surface tensions. In a preferred evaluation technique, surface tension of water is modified by incorporating increasing amounts of a miscible surface tension reducing liquid, such as isopropyl alcohol. Water repellency is graded by identifying the highest numbered test liquid that does not wet the fabric surface. Other tests, such as use of a functionalized dye or similar marker to assist in indicating either the presence or absence of a coating, may be used as will be apparent to the skilled artisan.

As noted above, the first layer is considered to reinforce the fabric substrate if the fabric has greater structural integrity under conditions of wear as compared to a like fabric substrate without the stain resistant layer. Under this evaluation, fabric samples are exposed to wear conditions in a controlled manner and compared to determine the relative condition of the fabric. Procedures to impart wear forces to the fabric and for evaluation of the relative condition of the fabric may be carried out by protocols that will be apparent to one of ordinary skill of the art. Preferably, standardized wear protocols, such as the Wyzenbeek abrasion protocol, are used. Such protocols are to be carried out with sufficient force and duration as to cause at least one set of samples to exhibit visible wear, such as damage to or displacement of fabric filaments. The wear may be evaluated visibly by the unaided eye, or more preferably through the use of photomicroscopy. The use of photomicroscope images is particularly useful because such images can be overlaid with a grid and compared to identify deviations from the original construction of the fabric, or closely examined to identify damage to fabric filaments.

A layer is considered to be stain resistant if when a staining material wets onto the surface of a substrate, the staining material is more easily removed from the substrate by conventional cleaning techniques than from a like substrate without the stain resistant layer. Such stain removal evaluation tests are common in the fabric industry, and may include controlled application of cleaning substances, optionally in a predetermined sequential format, to evaluate the ease of removing certain staining materials, such as mustard, blood, and so forth.

### EXPERIMENTAL

### Example 1

### Example 1A

A first layer coating composition bath was prepared having the following chemical make-up:

| Reagent | Amount/100# batch | Activity |
|---|---|---|
| Urethane (WIF41-035) | 8# | 35% |
| Acrylic Copolymer | 2.6# | 48% |
| (T138) | | |
| Amine Oxide | 0.01# | 100% |
| Aziridine | 0.04# | 100% |
| H₂O | 89.5# | n/a |

The acrylic copolymer, Hycar T-138, had a glass temperature transition of −20° C., which permitted the blending of this acrylic copolymer, at low concentration, with an extremely hard polymer, namely, the urethane latex, WF 41-035, and, yet, the pliability of the resultant fabric was maintained. The acrylic copolymer had active hydrogen groups, carboxyl, and sulfonate, making it possible to crosslink this acrylic copolymer with itself or other polymer systems sharing the same type of functionality.

The resulting composition was held in a container overnight, and transferred to a bench scale padding (i.e. coating) system. A polyester Jacquard fabric (commercially available from OMNOVA Solutions, Inc. as “Confetti” pattern fabric) was coated according to the present invention.

The first layer coating composition bath had a 4 percent total solids concentration, inclusive of the small concentration of trifunctional aziridine (a crosslinker) and amine oxide (a non-rewetter). The wet pick-up in this first layer pass was 50 percent, yielding a theoretical dry pick-up of 2 percent.

The first layer coating composition was caused to form a first layer by passing the coated fabric over heating cans at 175° F. to cure the composition. The acrylic copolymer/urethane coating provides stain resistance, and was chosen based upon its affinity and adhesion with the polyester fabric. The softer acrylic latex coalesces and crosslinks with the extremely hard polycarbonate urethane and provides a first layer with appreciable strength, which would not be the case if the fluoropolymer were present in the composition.

The treated fabric was then back coated with a conventional acrylic latex at a wet pick-up of 47 percent and dry pick-up of 22 percent, and was thereafter completely dried and cured in an oven at 350° F.

Next, the fabric was passed through a fluoropolymer composition bath so that the fluoropolymer could be incorporated on to the first layer that was formed in the first pass. The fluoropolymer composition bath was made up as follows:

| Reagent | Amount/100 # batch | Activity |
|---|---|---|
| Fluropolymer | 10# | 30% |
| (Sequapel GFC) | | |
| Amine Oxide | 0.03# | 100% |
| Aziridine | 0.2# | 100% |
| H₂O | 89.5# | n/a |

The wet pick-up of the fluoropolymer was 50 percent, corresponding to a theoretical dry pick-up of 1.5 percent. The fluoropolymer was covalently bonded to the surface of the acrylic copolymer/urethane first layer through the aziridine crosslinking agent, upon passing the coated fabric over heating cans at 175° F. The fluoropolymer was applied as a second coat, and it repels water as well as dirt and grime materials. It is an extremely durable coating, and, if it is worn away or penetrated, the first layer continues to provide stain resistance.

The treated fabric was back coated a second time with the conventional acrylic latex at a wet pick-up of 47 percent and dry pick-up of 22 percent, and was thereafter completely dried and cured in an oven at 350° F.

The following comparative examples are provided to show that the sequential application of a first layer coating composition and a fluoropolymer is not the equivalent of employing a single coating comprising all of the components.

### Example 1B

### Comparative

In this example, the same chemical compositions were employed as that of Example 1 A. However, in this example, a single coating operation was employed. That is, all of the chemical compositions were blended together as a single composition bath and then applied to the polyester fabric in one pass. The ratio of acrylic copolymer/urethane to fluoropolymer was 17/40/43, as was the ratio in Example 1A, but in two separate coatings. The same dry pick-up as in Example 1A was also employed, i.e., theoretical 3.5% dry pick-up.

### Example 1C

### Comparative

This is a single padding operation, as that described in the Hi-Tex patents, hereinabove. Here, Sequapel fluoropolymer was the only coating composition, and a theoretical 4.5% dry pick-up was employed.

The coated fabrics of Examples A, B and C were cut into four inch by fourteen inch strips and laminated onto glass with a two-sided adhesive tape, such that no back coating chemistry would interfere with the cleanability and durability evaluations to be made. These samples were then stained with black shoe polish (liquid), betadine, blue ball point pen (ink), black permanent marker and mustard, and were allowed to sit for a period of one hour.

As these stains were applied, the physical characteristics of the samples were documented, such as stain repulsion and/or wettability. After each staining cycle, the samples were flushed with a liberal amount of water, placed in a BYK Gardner scrub apparatus and scrubbed aggressively, for fifty scrub cycles with a water-based cleaner, particularly, Formula 409™. A single scrub cycle includes a forward and return pass of the brush. These samples were then flushed again with water, and stain appearance and fabric defects were documented before the samples were scrubbed for an additional fifty cycles with 100 percent isopropyl alcohol (IPA), a solvent-based cleaner. Stain appearance and fabric defects after treatment with isopropyl alcohol were also documented. After both solvent/cleaners were evaluated (100 cycles) the samples were washed again, dried and re-stained of marked for the next 100 cycles and this regime was repeated two more times. The following tables depict the findings of the comparisons.

| STAIN RESULT RATING: | STAIN CHARACTERISTIC: |
|---|---|
| 5 = Negligible or no stain 20 | R - Repels |
| 4 = Slightly stained | W - Stain Wetting |
| 3 = Noticeably stained | |
| 2 = Considerably stained | |
| 1 = Heavily stained | |

For wetting stains such as shoe polish, betadine and mustard, stain characteristics were evaluated. Non-wetting stains, such as blue ink and black marker could not be evaluated for stain characteristics.

TABLE I
Coated Fabrics Exposed to Shoe Polish

| | Cycles | | | | | | | |
|---|---|---|---|---|---|---|---|---|
| | 100 | | 200 | | 300 | | 400 | |
| | Shoe Polish | | Shoe Polish | | Shoe Polish | | Shoe Polish | |
| | Formula 409 | | | | | | | |
| Sam- | Staining | | Staining | | Staining | | Staining | |
| ple | Characteristic | | Characteristic | | Characteristic | | Characteristic | |
| A | 5 | R | 5 | R | 5 | R | 4 | W |
| B | 5 | R | 5 | R | 1 | W | 1 | W |
| C | 2 | W | 2 | W | 1 | W | 1 | W |
| IPA | | | | | | | | |
| A | 5 | R | 5 | R | 5 | R | 5 | R |
| B | 5 | R | 3 | W | 2 | W | 2 | W |
| C | 5 | W | 4 | W | 1 | W | 1 | W |

As is evident from Table I, stain ratings value and resistance were greatest for Sample A, representing the present invention. For Sample B, where all polymeric components of Sample A were combined and applied in a single coating, stain resistance failed after the first 200 scrub cycles and stain rating indicated heavy staining after the first 300 scrub cycles. For Sample C, where only a fluoropolymer coating was applied, stain wetting occurred within the first 100 scrub cycles and staining was considerable. For both Samples B and C, stain resistance was better in IPA than in the detergent; however, stain wetting quickly occurred after only 100 scrub cycles.

TABLE II
Coated Fabrics Exposed to Betadine

| | Cycles | | | | | | | |
|---|---|---|---|---|---|---|---|---|
| | 100 | | 200 | | 300 | | 400 | |
| | Betadine | | Betadine | | Betadine | | Betadine | |
| | Formula 409 | | | | | | | |
| Sam- | Staining | | Staining | | Staining | | Staining | |
| ple | Characteristic | | Characteristic | | Characteristic | | Characteristic | |
| A | 5 | R | 5 | R | 5 | R | 5 | R |
| B | 4 | R | 4 | W | 1 | W | 1 | W |
| C | 4 | W | 4 | W | 3 | W | 2 | W |
| IPA | | | | | | | | |
| A | 5 | R | 5 | R | 5 | R | 5 | R |
| B | 5 | R | 3 | W | 2 | W | 1 | W |
| C | 5 | W | 4 | W | 4 | W | 3 | W |

As is evident from Table II, stain ratings value and resistance were greatest for Sample A, representing the present invention. For Sample B, where all polymeric components of Sample A were combined and applied in a single coating, stain resistance failed after the first 300 scrub cycles and heavy staining occurred after the first 200 scrub cycles. Considering Sample C, here only a fluoropolymer coating was applied, stain wetting was marginally better than for Sample B while staining was considerable. None of the results were as good as for Sample A. For both Samples B and C, stain resistance was better in IPA than in the detergent; however, stain wetting quickly occurred after only 100 scrub cycles.

TABLE III
Coated Fabrics Exposed to Blue Ink

| | Cycles | | | |
|---|---|---|---|---|
| | 100 | 200 | 300 | 400 |
| | Blue Ink | Blue Ink | Blue Ink | Blue Ink |
| | Formula 409 | | | |
| Sam- | Staining | Staining | Staining | Staining |
| ple | Characteristic | Characteristic | Characteristic | Characteristic |
| A | 3 | 3 | 5 | 4 |
| B | 5 | 5 | 2 | 1 |
| C | 1 | 1 | 1 | 1 |
| IPA | | | | |
| A | 5 | 5 | 5 | 5 |
| B | 5 | 2 | 2 | 2 |
| C | 5 | 3 | 1 | 1 |

As is evident from Table III, stain ratings began slightly lower for Sample A than for Sample B, where all polymeric components of Sample A were combined and applied in a single coating, but Sample B failed thereafter. For Sample C, where only a fluoropolymer coating was applied, staining was generally heavy. Stain wetting was not determined. For Sample C, stain resistance was better in IPA than in the detergent; however, the fabric began failing after 100 scrub cycles.

TABLE IV
Coated Fabrics Exposed to Black Marker

| | Cycles | | | |
|---|---|---|---|---|
| | 100 | 200 | 300 | 400 |
| | Black Marker | Black Marker | Black Marker | Black Marker |
| | Formula 409 | | | |
| Sam- | Staining | Staining | Staining | Staining |
| ple | Characteristic | Characteristic | Characteristic | Characteristic |
| A | 2 | 2 | 3 | 3 |
| B | 4 | 4 | 1 | 1 |
| C | 1 | 1 | 1 | 1 |
| IPA | | | | |
| A | 5 | 4 | 4 | 4 |
| B | 4 | 1 | 2 | 2 |
| C | 5 | 2 | 1 | 1 |

As is evident from Table IV, stain ratings began lower for Sample A than for Sample B, where all polymeric components of Sample A were combined and applied in a single coating, but Sample B failed thereafter. For Sample C, where only a fluoropolymer coating was applied, staining was generally heavy. Stain wetting was not determined. For Sample C, stain resistance was better in IPA than in the detergent, but began failing after only 100 scrub cycles.

TABLE V
Coated Fabrics Exposed to Mustard

| | Cycles | | | | | | | |
|---|---|---|---|---|---|---|---|---|
| | 100 | | 200 | | 300 | | 400 | |
| | Mustard | | Mustard | | Mustard | | Mustard | |
| | Formula 409 | | | | | | | |
| Sam- | Staining | | Staining | | Staining | | Staining | |
| ple | Characteristic | | Characteristic | | Characteristic | | Characteristic | |
| A | 5 | R | 5 | R | 5 | R | 5 | R |
| B | 5 | R | 5 | W | 3 | W | 2 | W |
| C | 4 | W | 4 | W | 4 | W | 4 | W |
| IPA | | | | | | | | |
| A | 5 | R | 5 | R | 5 | R | 5 | R |
| B | 5 | R | 5 | W | 4 | W | 4 | W |
| C | 5 | W | 5 | W | 4 | W | 4 | W |

As is evident from Table V, stain ratings value and resistance were greatest for Sample A, representing the present invention. For Sample B, where all polymeric components of Sample A were combined and applied in a single coating, stain resistance failed after the first 200 scrub cycles and stain rating indicated heavy staining after the first 400 scrub cycles. For Sample C, where only a fluoropolymer coating was applied, stain wetting occurred within the first 100 scrub cycles although staining was comparable to Sample B. For both Samples B and C, stain resistance was better in IPA than in the detergent; however, stain wetting quickly occurred after only 100 to 200 scrub cycles.

TABLE VI
Fabric Appearance after Scrubbing

| | Cycles | | | |
|---|---|---|---|---|
| | 100 | 200 | 300 | 400 |
| | Fabric Look | Fabric Look | Fabric Look | Fabric Look |
| | Formula 409 | | | |
| Sam- | Staining | Staining | Staining | Staining |
| ple | Characteristic | Characteristic | Characteristic | Characteristic |
| A | Good | Good | Good | Good |
| B | Good | Good | Poor | Poor |
| C | Good | Good | Fair | Fair |
| IPA | | | | |
| A | Good | Good | Good | Good |
| B | Good | Fair | Poor | Poor |
| C | Good | Good | Poor | Poor |

As is evident from Table VI, fabric appearance was good for Sample A, throughout the entire scrub cycles while Samples B and C eventually became poor.

### Example 2

Composition Preparation

Coatings were applied to a plain woven polyester fabric which was free of any sizing agents to evaluate compositions applied as a single layer vs. a two-layer system, and also to show the effect of delaying application of pre-prepared coating compositions to the fabric for 24 hours.

More specifically, samples were prepared using formulations and application protocols as set forth in Table VII:

TABLE VII
Sample and process identification

| Sample ID | Description |
|---|---|
| A₀ | 2 layer system, applied immediately after |
| | formulations prepared. Cationic Fluoropolymer |
| B_{0(comparative)} | 1 layer system, applied immediately after |
| | formulation prepared. Cationic Fluoropolymer |
| C₀ | 2 layer system, applied immediately after |
| | formulations prepared. Amphoteric Fluoropolymer |
| D_{0(comparative)} | 1 layer system, applied immediately after |
| | formulation prepared. Amphoteric Fluoropolymer |
| A₂₄ | 2 layer system, applied 24 hours after |
| | formulations were made. Cationic Fluoropolymer |
| B_{24(comparative)} | 1 layer system, applied 24 hours after |
| | formulation was made. Cationic Fluoropolymer |
| C₂₄ | 2 layer system, applied 24 hours after |
| | formulations were made. Amphoteric Fluoropolymer |
| D_{24(comparative)} | 1 layer system, applied 24 hours after |
| | formulation was made. Amphoteric Fluoropolymer |

The two layer systems utilized a first layer composition comprising a polycarbonate urethane acrylic emulsion, a non-rewetting surfactant, and a cross-linker. This composition had a targeted solids content of 4%. Two second layer compositions were evaluated, one being a water based cationic fluoropolymer, Sequapel GFC from OMNOVA, and the other being an amphoteric fluoropolymer, Zonyl® 8412 from Dupont. The second layer compositions had a targeted solids content of 3%. See Tables VIIIA, VIIIB, VIIIC, and VIIID.

The one layer systems utilized the same components as the two layer system described above, with all components provided as a single composition with a targeted solids of 7%. See Tables VIIIE and VIIIF.

TABLE VIIIA
Table VIIIA
formulation for Samples A₀ & A₂₄ First layer composition (A-1)

| | % solids in reagent as | |
|---|---|---|
| Reagent | supplied | % Composition |
| WF41 -035 | 35 | 9.6 |
| Water | 0 | 87.5 |
| AcryGen 4290 | 59 | 2.5 |
| Mykon NRW-3 | 30 | .4 |
| Xama-7 | 100 | .05 |

TABLE VIIIB
Formulation for Samples A₀ & A₂₄ Second layer composition (A-2)

| | % solids in reagent as | |
|---|---|---|
| Reagent | supplied | % Composition |
| Sequapel GFC | 30 | 12 |
| Water | 0 | 87.4 |
| Mykon NRW-3 | 30 | .4 |
| Xama-7 | 100 | .2 |

TABLE VIIIC
Formulation for Samples C₀ & C₂₄ First layer composition (C-1)

| | % solids in reagent as | |
|---|---|---|
| Reagent | supplied | % Composition |
| WF41 -035 | 35 | 9.6 |
| Water | 0 | 87.5 |
| AcryGen 4290 | 59 | 2.5 |
| Mykon NRW-3 | 30 | .4 |
| Xama-7 | 100 | .05 |

TABLE VIIID
Formulation for Samples C₀ & C₂₄ Second layer composition (C-2)

| | % solids in reagent as | |
|---|---|---|
| Reagent | supplied | % Composition |
| Zonyl 8412 | 30 | 10 |
| Water | 0 | 89.4 |
| Mykon NRW-3 | 30 | .4 |
| Xama-7 | 100 | .2 |

TABLE VIIIE
Formulation for Samples B₀ & B₂₄ Single layer composition

| | % solids in reagent as | |
|---|---|---|
| Reagent | supplied | % Composition |
| WF41 -035 | 35 | 9.6 |
| Water | 0 | 77.5 |
| AcryGen 4290 | 59 | 2.5 |
| Mykon NRW-3 | 30 | .4 |
| Xama-7 100 | 100 | .05 |
| Sequapel GFC | 30 | 10 |

TABLE VIIIF
Formulation for Samples D₀ & D₂₄ Single layer composition

| | % solids in reagent as | % |
|---|---|---|
| Reagent | supplied | Composition |
| WF41 -035 | 35 | 9.6 |
| Water | 0 | 77.5 |
| AcryGen 4290 | 59 | 2.5 |
| Mykon NRW-3 | 30 | .4 |
| Xama-7 | 100 | .05 |
| Sequapel GFC | 30 | 10 |

Composition Solids Evaluation

Liquid samples were extracted from each formulation, and total solids of the liquid portion of the composition was evaluated to determine the compatibility and stability of the compositions. Thus, if solids have precipitated or segregated from the liquid portion of the composition, these solids will not be transferred to the fabric in the padding operation, reducing the actual coating weight of the layer on the fabric. The result of this analysis is presented in Table IX.

TABLE IX
Formulation Stability

| Sample Identification | Theoretical Solids | Tested Solids | Observations |
|---|---|---|---|
| A-1₀ | 4% | 4.22% | Stable |
| A-2₀ | 3% | 3.37% | Stable |
| B₀ | 7% | 4.19% | Flocculation |
| C-1₀ | 4% | 4.18% | Stable |
| C-2₀ | 3% | 3.67% | Stable |
| D₀ | 7% | 5.67% | Flocculation |
| A-1₂₄ | 4% | 4.32% | Stable |
| A-1₂₄ | 3% | 2.89% | Stable |
| B₂₄ | 7% | 2.67% | Flocculation |
| C-1₂₄ | 4% | 4.34% | Stable |
| C-1₂₄ | 3% | 3.42% | Stable |
| D₂₄ | 7% | 3.93% | Flocculation |

Sample Preparation

Samples were prepared by a conventional padding operation, wherein the fabric is drawn through the composition as indicated. The targeted wet pick-up of all the samples were 50%, based on fabric substrate weight. The samples were dried at 275° F. for a period of 5 minutes after immersion in each coating formulation.

Sample Evaluation

Once fabric samples had been prepared, they were subjected abrasion in accordance with ASTM D4157-92, Abrasion Resistance of Textile Fabrics. Under this test protocol, the sample was exposed to 10,000 cycles on the Wyzenbeek abrasion test instrument having 2 lbs pressure on the specimen with 6 lbs tension, using a stainless steel screen (surface screen 50×70 mesh, support screen 14-18 mesh).

Hydrophobicity Testing was then performed on both the abraded and non-abraded areas of all the samples. Testing was conducted first to show the effects of coating efficiency as it relates to repellency before and after abrasion. The test performed is similar to AATCC Test Method 188-1997. Instead of using hydrocarbon materials, however, graduated solutions of isopropyl alcohol and water were prepared having increasing relative proportions of isopropyl alcohol. As the amount of isopropyl alcohol in the water solution increases, the surface tension of the mixture declines.

Water repellency is graded by identifying the test liquid having the lowest surface tension that does not wet the fabric surface. In the test as carried out, the scale for performance runs from 1 to 9, with “1” being 100% water, i.e. highest surface tension least likely to wet the fabric substrate, and “9” being 20% water/80% isopropyl alcohol, i.e. very low surface tension and most likely to wet the surface. Specific identification of the test liquids is set forth in Table X.

TABLE X
Test liquid composition and Identification

| Identification # | Test liquid composition |
|---|---|
| 1 | 100% water |
| 2 | 95% water 5% Isopropyl Alcohol |
| 3 | 85% water 15% Isopropyl Alcohol |
| 4 | 75% water 25% Isopropyl Alcohol |
| 5 | 50% water 50% Isopropyl Alcohol |
| 6 | 40% water 60% Isopropyl Alcohol |
| 7 | 30% water 70% Isopropyl Alcohol |
| 8 | 20% water 80% Isopropyl Alcohol |
| 9 | 10% water 90% Isopropyl Alcohol |

The protocol for evaluating how the droplet wets the surface is set forth in AATCC method 118-1997 as follows:

A=Passes; Clear well-Rounded Drop

B=Borderline Pass; Rounded Drop With Partial Darkening

C=Fails; Wicking Apparent and/or Complete Wetting

D=Fails; Complete Wetting

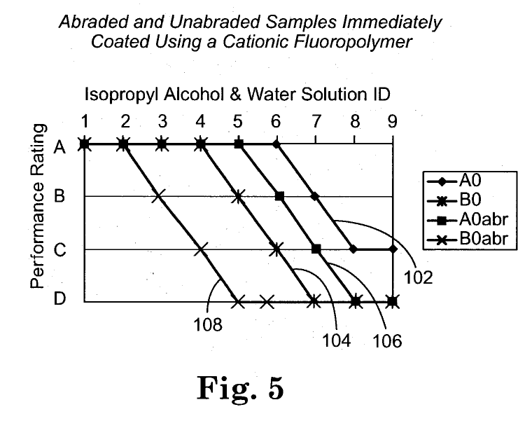

Thus, the higher the test solution number that a sample “passes,” the more hydrophobic the sample. Test results are reported in Table XI, which data is also presented in graph form in FIGS. 5-9.

TABLE XI
Water Repellency test data

| | | | | | | | | |
|---|---|---|---|---|---|---|---|---|
| Solution ID | A₀ | B₀ | C₀ | D₀ | A₂₄ | B₂₄ | C₂₄ | D₂₄ |

Non-Abraded Coated Samples

| | | | | | | | | |
|---|---|---|---|---|---|---|---|---|
| 1 | A | A | A | A | A | A | A | A |
| 2 | A | A | A | A | A | A | A | A |
| 3 | A | A | A | A | A | A | A | A |
| 4 | A | A | A | A | A | A | A | A |
| 5 | A | B | A | B | A | B | A | B |
| 6 | A | C | A | C | A | C | A | C |
| 7 | B | D | B | D | B | D | B | D |
| 8 | C | | C | | C | | C | |
| 9 | C | | D | | D | | D | |

Abraded Coated Samples

| | | | | | | | | |
|---|---|---|---|---|---|---|---|---|
| 1 | A | A | A | A | A | A | A | A |
| 2 | A | A | A | B | A | A | A | B |
| 3 | A | B | A | C | A | B | A | C |
| 4 | A | C | A | D | A | C | A | D |
| 5 | A | D | A | | B | D | B | |
| 6 | B | | B | | C | | C | |
| 7 | C | | C | | C | | D | |
| 8 | D | | D | | D | | | |
| 9 | | | | | | | | |

Turning again to the drawings, FIG. 5 is a graphic representation of the hydrophobicity data generated as discussed above. The samples represented in this Figure are two-layer and one-layer coatings, wherein the fluoropolymer is cationic in nature. As can be seen in FIG. 5, samples that are coated using the two step process of the present invention exhibit more hydrophobicity than samples that are coated using the one step process. Compare Test Result Line 102, which represents an unabraded sample of the present invention, with Test Result Line 104, which represents an unabraded sample having the coating compositions combined to form one layer.

FIG. 5 also presents data regarding the same samples after having been abraded as described above. Some reduction in hydrophobicity is observed in the sample of the present invention after abrasion, as reflected in the left-ward shift of the corresponding Test Result lines. Compare Test Result Line 102 with Test Result Line 106. However, the degree of hydrophobicity in the abraded inventive sample is still greater than that of the unabraded one step application technique. Compare Test Result Line 106 with Test Result Line 104. Furthermore, an even greater reduction in hydrophobicity is observed in the sample that is coated using the one step process. Compare Test Result Line 104 with Test Result Line 108. The coating of the two step process is therefore more effectively retained on the fabric after abrasion than the coating of the one step process.

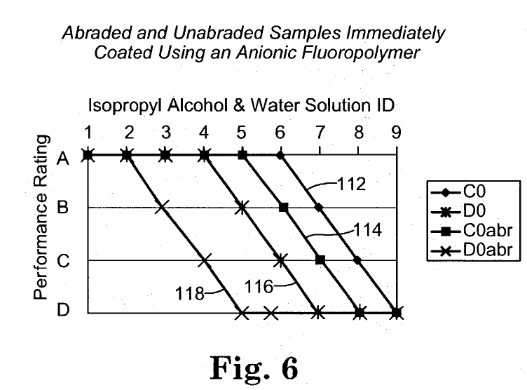

FIG. 6 presents data showing that samples coated using the two step process of the present invention and using amphoteric fluoropolymers exhibit more hydrophobicity than samples that are coated using the one step process. Compare Test Result Line 112, which represents an unabraded sample of the present invention, with Test Result Line 114, which represents an unabraded sample having the coating compositions combined to form one layer. As observed in the data of FIG. 5 above, a reduction in hydrophobicity is observed after abrasion of the samples. As in the cationic fluoropolymer case, the degree of reduction in hydrophobicity in the abraded amphoteric inventive sample is still greater than that of the unabraded amphoteric one step application technique. Compare Test Result Line 116 with Test Result Line 114. However, in the case of an amphoteric fluoropolymer, an even greater shift in hydrophobicity is observed when the sample is coated using the one step process. Compare Test Result Line 112 with Test Result Line 118. The coating of the two step process is more effectively retained on the fabric after abrasion than the coating of the one step process.

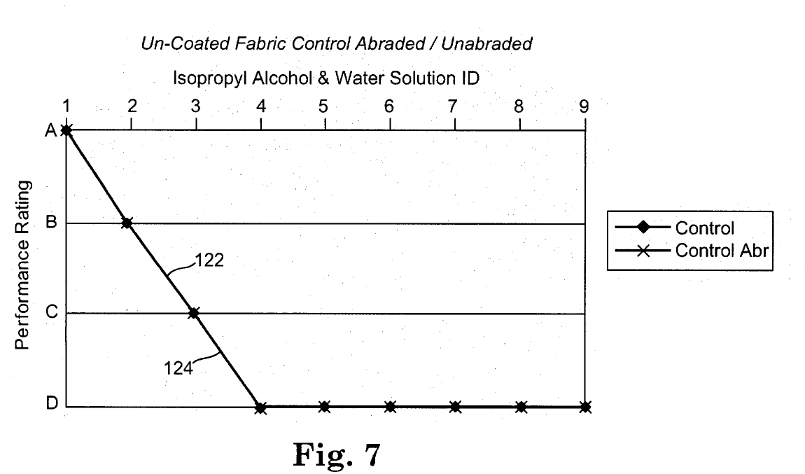

FIG. 7 is a graphic presentation of hydrophobicity data for an uncoated fabric, or control, sample. As can be seen by reference to Test Result Line 122, the uncoated fabric exhibits relatively poor hydrophobicity properties. This result is unaffected by abrasion, as shown by the unity of Test Result line 122 and Test Result line 124. In comparing the data presented in FIGS. 5 and 6 to the data presented in FIG. 7, it can be seen that upon abrasion of the sample where the coating is applied using the one step technique, the hydrophobicity of the sample is reduced to almost the same level as that of an untreated sample. Compare Test Result Lines 108 and 118 with Test Result Line 124.

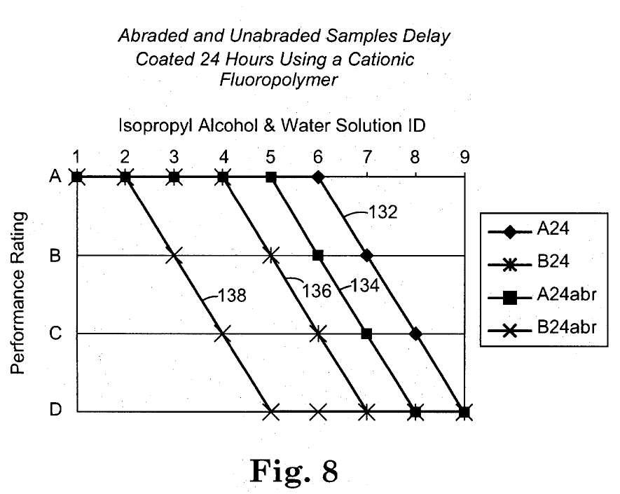

The same patterns of lower hydrophobicity, and lower retention of coatings on the fabric after abrasion are observed when the coatings are applied to the fabric after retention of the coating compositions for 24 hours. More specifically, FIG. 8 presents data samples wherein the fluoropolymer is cationic in nature. As can be seen in FIG. 8, samples that are coated using the two step process of the present invention exhibit more hydrophobicity than samples that are coated using the one step process. Compare Test Result Line 132, which represents an unabraded sample of the present invention, with Test Result Line 134, which represents an unabraded sample having the coating compositions combined to form one layer. FIG. 8 also presents data regarding the same samples after having been abraded as described above. The hydrophobicity of the sample is reduced after abrasion, as reflected in the left-ward shift of the corresponding Test Result lines. Compare Test Result Line 132 with Test Result Line 136, wherein the line is shifted one place to the left. However, the degree of hydrophobicity in the abraded inventive sample is still greater than that of the unabraded one step application technique. Compare Test Result Line 136 with Test Result Line 134. Additionally, an even greater shift in hydrophobicity is observed for the sample that is coated using the one step process. Compare Test Result Line 134 with Test Result Line 138, wherein the line is shifted two spaces to the left. The coating of the two step process is better retained on the fabric after abrasion than the coating of the one step process.

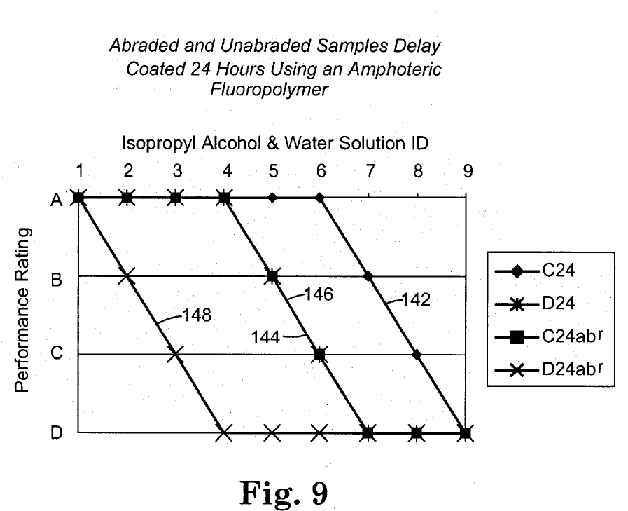

The observed reduction in hydrophobicity is even more pronounced for samples using amphoteric fluoropolymers (i.e. the fluoropolymers actually used, for example, in U.S. Pat. No. 5,747,392) where the coating process is delayed for 24 hours from formulation preparation. FIG. 9 presents data showing that samples coated using the two step process of the present invention exhibit more hydrophobicity than samples that are coated using the one step process. Compare Test Result Line 142, which represents an unabraded sample of the present invention, with Test Result Line 144, which represents an unabraded sample having the coating compositions combined to form one layer. FIG. 9 also presents data regarding the same samples after having been abraded as described above. The hydrophobicity of the sample is reduced after abrasion, as reflected in the left-ward shift of the corresponding Test Result lines. Compare Test Result Line 142 with Test Result Line 146, wherein the line is shifted two places to the left: However, the degree of hydrophobicity in the abraded inventive sample is the same as that of the unabraded one step application technique. Compare Test Result Line 146 with Test Result Line 144. Moreover, an even greater shift in hydrophobicity is observed for the sample that is coated using the one step process. Compare Test Result Line 144 with Test Result Line 148, wherein the line is shifted three spaces to the left. The coating of the two step process is better retained on the fabric after abrasion than the coating of the one step process.

In comparing the data presented in FIGS. 8 and 9 to the data presented in FIG. 7, it can be seen that upon abrasion of the sample where the coating is applied using the one step technique, the hydrophobicity of the sample is reduced to almost the same level in the case of cationic fluoropolymer, and the same level in the case of anionic fluoropolymer, as that of an untreated sample. Compare Test Result Lines 138 and 138 with Test Result Line 124.

The coated fabric of the present invention exhibits exceptional resistance to soil and stains, and therefore finds particular benefit as fabrics for use in high abuse situations. In one aspect, the fabrics of the present invention may be used in forming the outer surface of an article. For example, the fabric may be used in making furniture, including sofas, recliners, cushions, and the like. Fabrics of the present invention additionally may be used in any function suitable for fabric, such as fabric wall coverings, furniture, articles of apparel, outdoor structures such as awnings, and floor coverings such as rugs and carpets.

Particularly for use in industrial or commercial settings where high and potentially abusive use may be expected. In one preferred embodiment, the fabric may be used to prepare garments. Particularly preferred such garments include work coveralls, apron and other protective gear type garments. In a preferred aspect of the present invention, the fabric is printed with a design prior to application of the first and second layers.

A particularly preferred application for the fabrics of the present invention is in the health care field, where upholstered furniture and surfaces are commonly exposed to staining materials that are difficult to remove, such as blood and iodine-containing disinfectants. The fabrics of the present invention further provide significant health benefits when used as part of a patient support article for support of at least a part of a patient during health care treatment. Examples of patient support articles include chairs, examining tables, limb support boards, beds, couches and the like. This benefit is because the fabrics of the present invention characteristically do not allow penetration of liquids into or through the fabric. Under normal cleaning procedures, a fabric that has been stained with a liquid, such as blood, will have a liquid cleaning agent applied to the stain and an absorptive material, such as a washcloth, will be rubbed against the stain to attempt to remove the stain from the fabric. This cleaning process, when applied to fabrics treated with conventional stain repellants, tends to drive at least some of the stain material into and/or through the fabric, thereby creating a reservoir of stain material under the fabric. When this stain material is blood or other organic material, the creation of this reservoir potentially provides a suitable environment for various microbes and other undesirable flora to grow. Because the fabric of the present invention exhibits minimal stain material transfer into or through the fabric during the cleaning process, its use as part of a patient support article in the health care environment is particularly advantageous.

Additionally, the fabric of the present invention is particularly desirable for use in area where the ability to repeatably and hygienically clean the surface is required. Such areas, for example include child care environments, child play areas and the like.

In light of the foregoing, it should thus be evident that the present invention, providing a coated fabric and method, substantially improves the art. Although the invention has been exemplified in the above examples, it is to be appreciated that these examples are non-limiting. Accordingly, based upon the disclosure herein of polymeric components for the coating compositions that form the first and second layers on the fabric, those skilled in the art should be able to select alternative first layer coating composition polymers as well as fluoropolymers with which to practice the invention, as well as suitable crosslinking agents, various surfactants and other components. Moreover, practice of the present invention is not limited to a particular fabric substrate.

While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

What is claimed is:

1. A hydrophobic, oleophobic and stain resistant fabric comprising:
a fabric substrate coated with a polymer system comprising:
a) a scrub resistant first layer; and
b) a second layer comprising a fluoropolymer bonded to the scrub resistant first layer.

2. The fabric of claim 1, wherein said first layer exhibits affinity to the fabric substrate through an interaction selected from the group consisting of coulombic interaction, ionic bonding, hydrogen bonding, London dispersion forces, dipole-dipole interactions and charge transfer complexation.

3. The fabric of claim 1, wherein said first layer exhibits affinity to the fabric substrate through covalent bonding.

4. The fabric of claim 1, wherein the fabric substrate is covalently bonded to the first layer with a crosslinking material.

5. The fabric of claim 1, wherein said first layer exhibits affinity to the fabric substrate through crosslinking of the first layer, thereby mechanically binding the first layer to the fabric substrate.

6. The fabric of claim 5, wherein the first layer is crosslinked by reaction of carboxyl functionalities in the first layer through an aziridine crosslinking material.

7. The fabric of claim 5, wherein the first layer is crosslinked by reaction of hydroxyl functionalities in the first layer through a melamine formaldehyde crosslinking material.

8. The fabric of claim 5, wherein the first layer is crosslinked by reaction of hydroxyl functionalities in the first layer through a urea formaldehyde crosslinking material.

9. The fabric of claim 1, wherein the first layer comprises a mixture of one or more soft polymers and one or more hard polymers.

10. The fabric of claim 9, wherein the soft polymers have a Tg of from 30° C. to about 0° C. and the hard polymers have a Tg of from about 120° C. to about 180° C.

11. The fabric of claim 9, wherein the first layer comprises from about 10% to about 45% of soft polymers have a Tg of from 30° C. to about 0° C. and about 55% to about 90% of hard polymers by weight.

12. The fabric of claim 9, wherein the first layer comprises from about 20 to about 35% of soft polymers and about 65 to about 80% of hard polymers by weight.

13. The fabric of claim 9, wherein the first layer includes a water-borne polycarbonate urethane with pendent carboxyl groups and a carboxylated acrylic copolymer.

14. The fabric of claim 1, wherein the second layer further comprises a polymer that is not a fluoropolymer.

15. The fabric of claim 1, wherein the fluoropolymer has been covalently bonded to the first layer through reactive carboxyl functionalities.

16. The fabric of claim 1, wherein the fluoropolymer has been covalently bonded to the first layer through reactive hydroxyl functionalities.

17. The fabric of claim 1, wherein the fluoropolymer comprises pendent fluorinated groups linked to the polymer through an ether linkage.

18. The fabric of claim 1, wherein the fluoropolymer comprises pendent fluorinated groups having a carbon chain length of equal to or less than four carbons.

19. The fabric of claim 1, wherein the fluoropolymer is prepared from monomers or oligomers comprising at least one fluorinated oxetane monomer.

20. The fabric of claim 1, further comprising at least one back coating.

21. A method for producing a hydrophobic, oleophobic and stain resistant fabric including the steps of
a) selecting a suitable fabric substrate;
b) applying a first layer coating composition comprising at least one polymer having reactive functional groups;
c) drying and curing said first layer coating composition, thereby forming a first layer having an affinity for the fabric substrate;
d) applying a second layer coating composition different from said first layer coating composition to said first layer, said second layer coating composition comprising a fluoropolymer having reactive functional groups; and, in either order
e) reacting at least a portion of the reactive functional groups of the fluoropolymer with at least a portion of the reactive functional groups of the first layer; and
f) drying and curing said second layer coating composition to form a second layer.

22. The method of claim 21, wherein the first layer is crosslinked, thereby mechanically binding the first layer to the fabric substrate.

23. The method of claim 22, wherein the first layer is crosslinked by use of a crosslinking agent.

24. The method of claim 23, wherein the reactive functional groups of the first layer comprise carboxyl functionalities.

25. The method of claim 24, wherein the first layer is crosslinked by a polyfunctional aziridine crosslinking agent.

26. The method of claim 23, wherein the reactive functional groups of the first layer comprise hydroxyl functionalities.

27. The method of claim 26, wherein the first layer is crosslinked by a crosslinking agent selected from the group consisting of melamine formaldehyde crosslinking agents and urea formaldehyde crosslinking agents.

28. The method of claim 21, wherein the fluoropolymer is covalently bonded to the first layer by use of a crosslinking agent.

29. The method of claim 28, wherein the reactive functional groups of the first layer and the fluoropolymer comprise carboxyl functionalities.

30. The method of claim 29, wherein the first layer and the fluoropolymer are covalently bonded by a polyfunctional aziridine crosslinking agent.

31. The method of claim 28, wherein the reactive functional groups of the first layer and the fluoropolymer comprise hydroxyl functionalities.

32. The method of claim 31, wherein the first layer and the fluoropolymer are covalently bonded by a crosslinking agent selected from the group consisting of melamine formaldehyde crosslinking agents and urea formaldehyde crosslinking agents.

33. The method of claim 21 wherein the fluoropolymer comprises pendent fluorinated groups linked to the polymer through an ether linkage.

34. The method of claim 21 wherein the fluoropolymer comprises pendent fluorinated groups having a carbon chain length of equal to or less than four carbons.

35. The method of claim 21 wherein the fluoropolymer is prepared from monomers or oligomers comprising at least one fluorinated oxetane monomer.

36. The method of claim 21, comprising the further step of applying at least one back coating.

37. An article comprising the fabric of claim 1 on an outer surface thereof.

38. The article of claim 37, wherein the article physically supports at least a part of a patient during health care treatment.

39. The article of claim 37, wherein the fabric has been printed with a design prior to application of the first and second layers.

40. A garment comprising the fabric of claim 1.
